(19) United States
(12) Patent Application Publication
(10) Pub. No.: US 2005/0071878 A1
(43) Pub. Date: Mar. 31, 2005

(54) Cradle, radio frequency receiving system, and radio frequency receiving method

(75) Inventors: Toshio Asano, Fukaya-shi (JP); Shuji Abe, Kumagaya-shi (JP); Koji Shingu, Fukaya-shi (JP); Tooru Umino, Fukaya-shi (JP); Masahiro Sekine, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/924,193

(22) Filed: Aug. 24, 2004

(30) Foreign Application Priority Data
Sep. 29, 2003 (JP) 2003-337754

(51) Int. Cl. H04N 7/18; G06F 17/60; H04L 9/00; H04N 7/16; H04N 7/173

(52) U.S. Cl. 725/78; 725/131; 725/151; 725/80; 705/74

(57) ABSTRACT

A cradle receives RF signals, performs level control of the RF signals, and emits the RF signals to a main-body unit installed to the cradle. When the main-body unit is installed, the cradle receives a video signal from the main-body unit, applies signal processing to the video signal, and then outputs it. Concurrently, the cradle outputs power-supply power to the main-body unit. Further, the cradle performs level control of the received RF signals to a first level when the main-body unit is installed, and performs level control of the received RF signals to a second level higher than the first level when the main-body unit is not installed.

### CROSS-REFERENCE TO RELATED APPLICATIONS

This application is based upon and claims the benefit of priority from prior Japanese Patent Application No. 2003-337754, filed Sep. 29, 2003, the entire contents of which are incorporated herein by reference.

### BACKGROUND OF THE INVENTION

1. Field of the Invention

The present invention relates to a cradle that is used to install a radio-frequency (RF) receiving device suitable for use with, particularly, a cellular broadcast receiving terminal that receives satellite digital broadcasts. In addition, the present invention relates to an RF receiving system containing the cradle and to an RF receiving method.

2. Description of the Related Art

As is well known, presently, a satellite digital broadcast system using the 2.6-GHz band is in development. In Japan, the satellite digital broadcast system would be the first system for implementing digital broadcasting primarily intended to be of service for mobile devices and cellular receiving devices.

The satellite digital broadcast system is categorized into systems that provide the service of high-quality audio broadcasting. Additionally, the system is greatly expected to be of service as a broadcast medium capable of distributing multimedia content containing simple motion images to cellular receiving devices.

Other systems scheduled for development include a terrestrial digital broadcast system designed to perform fixed reception. However, this system is limited in receivable range, and the system prerequisitely should be used near a transmission antenna. In comparison, as the name implies, the satellite digital broadcast system enables signal reception in all corners of wherefrom geostationary satellites can be observed.

For existing mobile terminals, techniques for imparting various additional functions are about to be established. Examples are techniques that provide additional functions by providing a stationary cradle, a power supply system for supplying the power from the outside, and interfaces primarily designed to implement information sharing and data exchange with other devices.

Among various additional functions as described above, a function important to the cellular broadcast receiving device is to supply RF signals to the receiving device from the outside to stabilize reception signals, particularly, in an environment, such as an indoor environment where radio waves hardly reach.

There is a technique of connecting an external antenna to a receiving device in order to supply RF signals from the outside to the receiving device. In this case, taking usability of the receiving device into account, the external antenna is prerequisitely detachable depending on the conditions, and is connected to the receiving device via a connector or the like.

In this case, a switch circuit needs to be provided in a signal input section of an RF circuit built into the receiving device to switch between an RF signal received through a built-in antenna and an RF signal supplied from the external antenna.

However, in a system for receiving very low intensity broadcast waves from satellites, the provision of components, circuitry, and the like that have associated signal losses degrades received signals. In addition, in the case of the cellular receiving device, which should be miniaturized, the configuration provided with spacing dominating the connector and switch circuit is not suitable for practical applications.

Further, as a technique for improving the reception conditions under unstable reception environments such as an indoor environment, it is contemplated to mount a retransmission device. The retransmission device is designed to receive an RF signal from a satellite and then to amplify the signal for transmission to a receiving device.

Even in a house where only very low intensity signals can be received, when the retransmission device is installed in a place, such as a place near the window or a balcony, where the reception environment is relatively stable, the signal reception condition in the indoor site can be improved.

In this case, the reception environment can be stabilized by increasing the magnitude of the transmission output from the retransmission device. However, in Japan, the sixth section of the Radio Wave Law, “Radio stations for which no license is required,” specifies the upper limit for the emission level of an RF wave from a radio station that may impose a disturbance on other peripheral devices.

In the 2.6-GHz band satellite digital broadcast system, general users who do not have a radio station operational license or the like use the retransmission device. In this connection, the reception environment can be assumed to be different depending on the usage site of each individual user. As such, for using the retransmission device, there arises the necessity of performing control to retransmission levels conforming to the Radio Wave Law even under various reception intensities.

Jpn. UM. Appln. KOKAI Publication No. 6-48207 discloses a configuration designed to improve unstable communication due to movement-associated variations in directivity and transmission/reception electric field intensity. To attain the improvement, the configuration is designed such that a pickup antenna connected to an external antenna via a power supply cable is electromagnetically coupled to a built-in antenna of a cellular radio telephone.

The publication thus discloses the configuration designed to stabilize communication that is performed using the cellular radio telephone. However, the publication does not have any description regarding stabilization of the reception condition by taking into account that, particularly, a cradle is installed in a cellular receiving device that receives satellite digital broadcasts.

### BRIEF SUMMARY OF THE INVENTION

According to one aspect of the present invention, there is provided a cradle having an installation portion in which a predetermined main-body unit is installed, comprising: first and second level control sections configured to perform level control of radio frequency (RF) signals supplied thereto; first and second emission sections configured to emit the RF signals having undergone the level control in the first and second level control sections, respectively; an video input terminal configured to receive a video signal from the main-body unit in a state where the main-body unit is installed in the installation portion; a signal processing section configured to apply predetermined signal processing to the video signal input to the video input terminal; a video output terminal configured to output the video signal processed in the signal processing section; a power input terminal configured to receive power-supply power; a power supply section configured to generate power to be supplied to the first and second level control sections, the first and second emission sections and the signal processing section in accordance with the power-supply power supplied to the power input terminal; a power output terminal configured to output the power generated in the power supply section to the main-body unit in the state where the main-body unit is installed in the installation portion; a detecting section configured to detect installation or non-installation of the main-body unit in the installation portion; and control section configured to control the RF signals to a first level for the first and second level control sections in a state where the installation of the main-body unit has been detected by the detecting section, and to control the RF signals to a second level higher than the first level for the first and second level control sections in a state where the non-installation of the main-body unit has been detected by the detecting section.

According to one aspect of the present invention, there is provided an RF receiver system comprising an RF receiving apparatus installed in a cradle, the cradle comprises: first and second level control sections configured to perform level control of radio frequency (RF) signals supplied thereto; first and second emission sections configured to emit the RF signals having undergone the level control in the first and second level control sections, respectively; an installation portion configured to install the RF receiving apparatus; a video input terminal configured to receive a video signal from the RF receiving apparatus in a state where the RF receiving apparatus is installed in the installation portion; a first signal processing section configured to apply a predetermined signal processing to the video signal input to the video input terminal; a first video output terminal configured to output the video signal processed in the first signal processing section; a first power input terminal configured to receive power-supply power; a first power supply section configured to generate power to be supplied to the first and second level control sections, the first and second emission sections, and the first signal processing section in accordance with the power-supply power supplied to the first power input terminal; a power output terminal configured to output the power generated in the first power supply section to the RF receiving apparatus in the state where the RF receiving apparatus is installed in the installation portion; a detecting section configured to detect installation or non-installation of the RF receiving apparatus in the installation portion; and control section configured to control the RF signals to a first level for the first and second level control sections in a state where the installation of the RF receiving apparatus has been detected by the detecting section, and to control the RF signals to a second level higher than the first level for the first and second level control sections in a state where the non-installation of the RF receiving apparatus has been detected by the detecting section, and the RF receiving apparatus comprises: first and second antennas configured to receive the RF signals emitted from the first and second emission sections, respectively; a second signal processing section configured to restore a video signal from the RF signals received by the first and second antennas; a display section configured to display the video signal restored in the second signal processing section; a second video output terminal configured to output the video signal restored in the second signal processing section to the video input terminal in the state where the RF receiving apparatus is installed in the installation portion; a second power input terminal configured to receive the power-supply power output from the power output terminal in the state where the RF receiving apparatus is installed in the installation portion; and a second power supply section configured to generate power to be supplied to the second signal processing section and the display section in accordance with the power-supply power supplied to the second power input terminal.

According to one aspect of the present invention, there is provided an RF receiving method to be executed by installing an RF receiving apparatus in a cradle, wherein: the cradle performs level control of received RF signals in first and second level control sections and emittes the RF signals after the level control; the RF receiving apparatus receives the individual RF signals emitted by the cradle, restores a video signal, and outputs the video signal; the cradle applies predetermined signal processing to the video signal output by the RF receiving apparatus and outputs the video signal; the cradle generates power to be used in the cradle in accordance with input power-supply power and outputs the power to the RF receiving apparatus; the cradle detects installation or non-installation of the RF receiving apparatus; and the cradle performs level control of the RF signals to be emitted to the RF receiving apparatus to a first level in a state where the installation of the RF receiving apparatus has been detected, and performs level control of the RF signals to be emitted to the RF receiving apparatus to a second level higher than the first level in a state where the non-installation of the RF receiving apparatus has been detected.

### BRIEF DESCRIPTION OF THE SEVERAL VIEWS OF THE DRAWING

FIG. 1 is a schematic diagram showing a satellite digital broadcast system according to an embodiment of the present invention;

FIG. 2 is a diagram showing an example of an installed state of a broadcast receiving terminal and an external antenna in a house according to the embodiment;

FIG. 3 is a perspective view showing an example of mounting means for the external antenna according to the embodiment;

FIG. 4 is a diagram showing another example of the installed state of the broadcast receiving terminal and the external antenna in the house according to the embodiment;

FIG. 5 is a perspective view showing another example of the mounting means for the external antenna according to the embodiment;

FIG. 6 is a perspective view showing a state as viewed from a front side, in which the broadcast receiving terminal according to the embodiment is installed to a cradle;

FIG. 7 is a perspective view showing a state as viewed from a rear side, in which the broadcast receiving terminal according to the embodiment is installed to the cradle;

FIG. 8 is a block diagram showing individual signal processing systems of the external antenna, the cradle, and the broadcast receiving terminal according to the embodiment;

FIG. 9 is a view showing an example of positional relationships between internal antennas of the broadcast receiving terminal and emission sections of the cradle according to the embodiment;

FIG. 10 is a view showing another example of the positional relationships between the internal antennas of the broadcast receiving terminal and the emission sections of the cradle according to the embodiment;

FIG. 11 is a view showing still another example of the positional relationships between the internal antennas of the broadcast receiving terminal and the emission sections of the cradle according to the embodiment;

FIG. 12 is a view showing still another example of the positional relationships between the internal antennas of the broadcast receiving terminal and the emission sections of the cradle according to the embodiment;

FIG. 13 is a perspective view showing a modified example of means for determining whether or not the broadcast receiving terminal is installed to the cradle according to the embodiment;

FIG. 14 is a perspective view showing a modified example according to the embodiment;

FIG. 15 is a perspective view showing another modified example according to the embodiment; and

FIG. 16 is a perspective view showing still another modified example according to the embodiment.

### DETAILED DESCRIPTION OF THE INVENTION

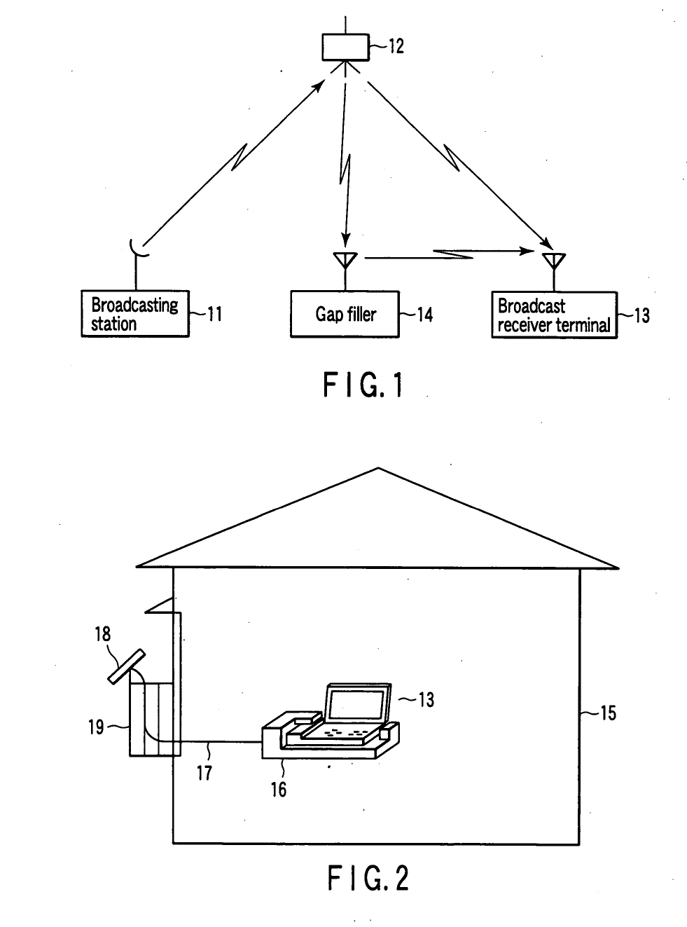

An embodiment of the present invention will be described in detail hereinbelow with reference to the drawings. FIG. 1 is a schematic view showing a satellite digital broadcast system according to the embodiment.

Broadcast content transmitted from a broadcasting station 11 is received by a cellular broadcast receiving terminal 13 being carried by a user, through a satellite 12 to be reproduced, whereby the content is reproduced for viewing/listening by the user.

In addition, in the satellite digital broadcast system, a broadcast radio wave from the satellite 12 is supplied via a gap filler 14 to the broadcast receiving terminal 13 existing in a site, such as an indoor site and an underground site, where the broadcast radio wave from the satellite 12 does not reach.

The broadcast receiving terminal 13 per se can be carried to an outdoor site to a broadcast radio wave from the satellite 12 or the gap filler 14, and broadcast content thereof can be reproduced.

As shown in FIG. 2, the broadcast receiving terminal 13 can be installed in a cradle 16 placed in a house 15, whereby a broadcast radio wave from the satellite 12 or the gap filler 14 can be received, and broadcast content thereof can be reproduced.

The cradle 16 inherently is a base in which the broadcast receiving terminal 13 is installed and stably held, thereby exhibiting the function of supplying the power to the installed broadcast receiving terminal 13. In the present embodiment, however, the cradle 16 further has additional function.

In this case, the cradle 16 is connected to an external antenna 18 through an antenna cable 17. The antenna cable 17 is disposed in a place, such as a balcony 19, where broadcast radio waves can be received well.

In the manner as described above, a broadcast signal received by the external antenna 18 is supplied to the broadcast receiving terminal 13 through the antenna cable 17 and the cradle 16. Thereby, even in an indoor site where radio waves hardly reach, reception thereof is stably enabled.

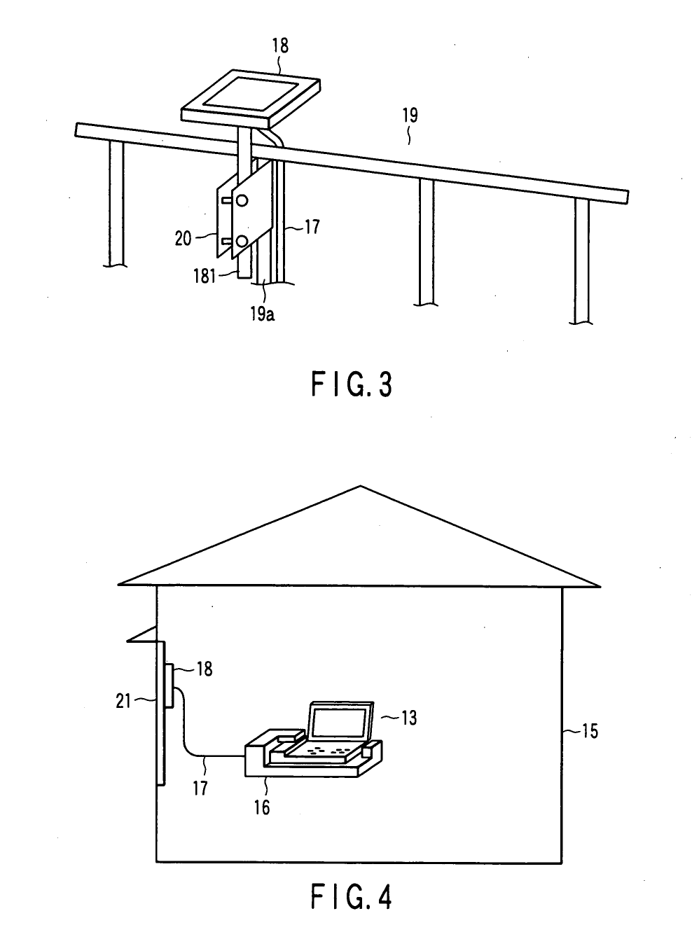

As shown in FIG. 3, the external antenna 18 can be mounted on a balcony 19 in such a manner that a mounting support column 181 is placed and is fixed to one of a plurality of support bodies 19a, which constitute the balcony 19, by using a predetermined fixture 20.

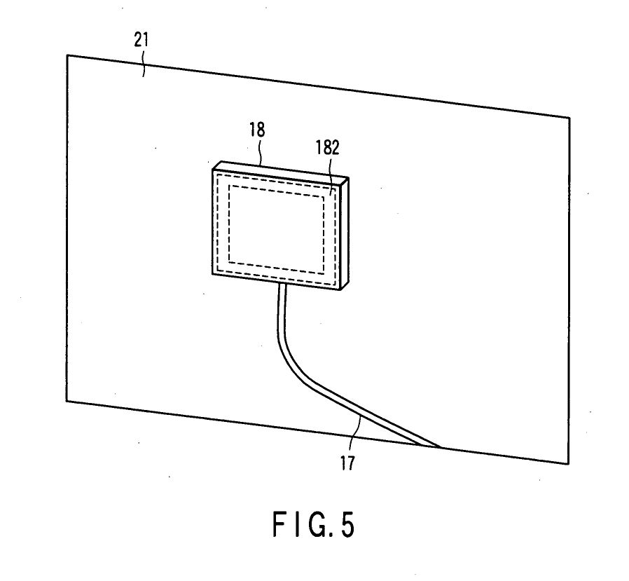

Alternatively, as shown in FIG. 4, the external antenna 18 can be mounted on a window glass 21 situated in the house 15. In this case, as shown in FIG. 5, the external antenna 18 is fixed to the window glass 21 by being adhered onto the window glass 21 by using double-sided adhesive tape 182.

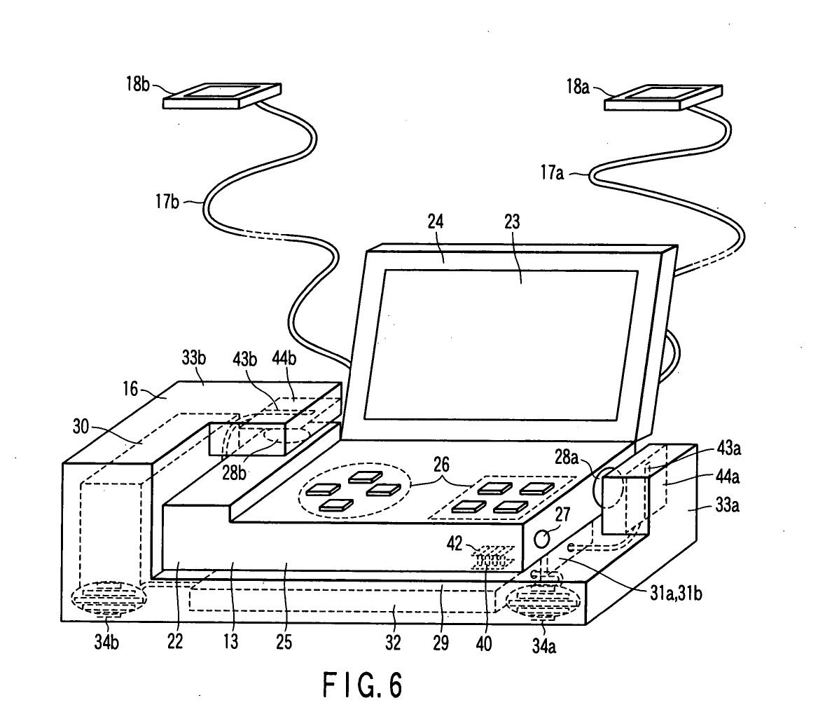

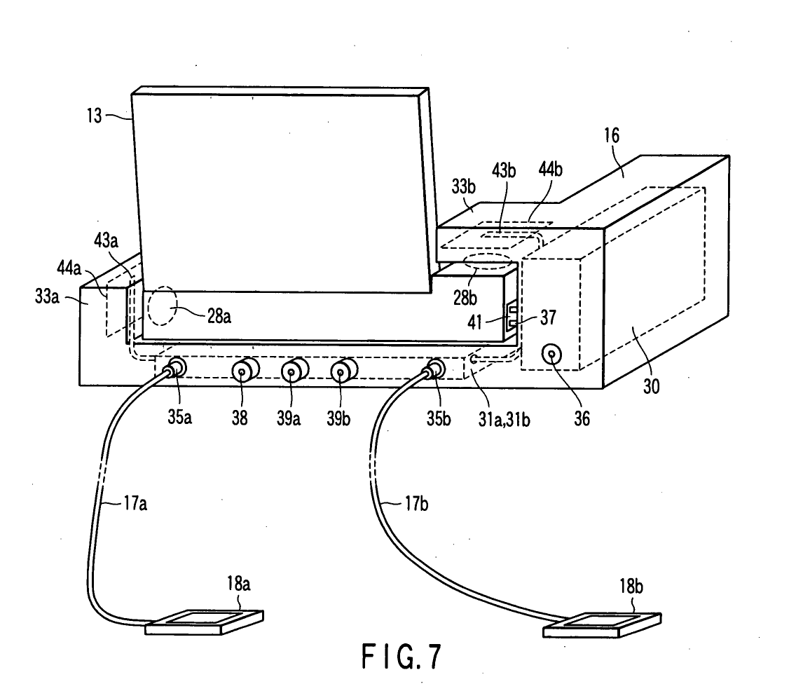

FIG. 6 is a perspective view showing a state, as viewed from a front side, in which the broadcast receiving terminal 13 is installed on the cradle 16. FIG. 7 is a perspective view showing a state, as viewed from a rear side, in which the broadcast receiving terminal 13 is installed on the cradle 16.

The broadcast receiving terminal 13 has a housing 22. The housing 22 is configured of a cover housing 24 containing a built-in video display panel 23 and a main-body housing 25. The cover housing 24 is configured to have the function of moving with respect to the main-body housing 25.

With the broadcast receiving terminal 13, the user can view images displayed on the video display panel 23 by operating individual buttons 26, such as those for performing channel switching, audio-volume adjustment, data edit, and power-on/off switching. Additionally, the user can listen to sounds by connecting an earphone to an earphone connection terminal 27.

The broadcast receiving terminal 13 has two systems of internal antennas 28a and 28b. The internal antenna 28a on the one side is disposed toward one sidewall of the main-body housing 25. The internal antenna 28b on the other side is disposed toward a zenith wall of the main-body housing 25.

The cradle 16, which is used as a supporting framework of the broadcast receiving terminal 13, has an installation portion 29 on its upper portion for the installation of the broadcast receiving terminal 13. Mainly provided inside the cradle 16 are a power supply circuit 30, two systems of signal-level control sections 31a and 31b, a video/audio processing circuit 32, two systems of emission sections 33a and 33b, and two systems of speakers 34a and 34b, for example.

Additionally, two systems of external-antenna connectors 35a and 35b, AC adapter connector 36, an external-power-supply conducting electrode 37, an external video output terminal 38, and two systems of external audio output terminals 39a and 39b are provided on a rear surface of the cradle 16. Further, video/audio input electrodes 40 are provider over an upper surface of the cradle 16, on which the broadcast receiving terminal 13 is installed.

First, the broadcast receiving terminal 13 is installed on the installation portion 29 of the cradle 16, the external-power-supply conducting electrode 37 provided in the cradle 16 is brought into contact with connection terminals 41 exposed on one sidewall of the broadcast receiving terminal 13. Thereby, the power is supplied from the power supply circuit 30 in the cradle 16 to the broadcast receiving terminal 13.

Concurrently, the video/audio input electrodes 40 also are brought into contact with connection terminals 42 exposed on the broadcast receiving terminal 13. Thereby, the video signal to be output from the broadcast receiving terminal 13 is passed through the video/audio processing circuit 32, and is then output from the external video output terminal 38 provided in the cradle 16. In addition, the audio signal to be output from the broadcast receiving terminal 13 is passed through the video/audio processing circuit 32, is then reproduced through the speakers 34a and 34b provided in the cradle 16, and is concurrently output from the external audio output terminals 39a and 39b provided to the cradle 16.

Subsequently, amplifier-containing external antennas 18a and 18b are connected, respectively, to the two systems of external-antenna connectors 35a and 35b disposed in the cradle 16 via antenna cables 17a and 17b each having a length of about 5 to 10 m. This enables the external antennas 18a and 18b to be removably attachable.

The RF signals received through the external antennas 18a and 18b are responsively supplied to the signal-level control sections 31a and 31b in the cradle 16, respectively. In this manner, the RF signals are controlled to be receivable by the broadcast receiving terminal 13, and are controlled to levels conforming to the Radio Wave Law.

After having been controlled for their levels in the signal-level control sections 31a and 31b, the RF signals are then output to the emission sections 33a and 33b installed at positions respectively corresponding to the internal antennas 28a and 28b of the broadcast receiving terminal 13.

Substrate components 44a and 44b in which pattern antennas 43a and 43b are formed are provided inside the two systems of emission sections 33a and 33b, respectively. Thereby, RF signals can be emitted to the internal antennas 28a and 28b of the broadcast receiving terminal 13.

The emission sections 33a and 33b are engineered to exhibit maximum efficiency for the transmission of RF signals to the respective internal antennas 28a and 28b of the broadcast receiving terminal 13, and are positioned in close proximity to and in opposition to the respective internal antennas 28a and 28b.

In addition, when the broadcast receiving terminal 13 is removed from the cradle 16, the signal-level control sections 31a and 31b operate such that emission levels from the respective emission sections 33a and 33b are increased within ranges conforming to the Radio Wave Law.

This means that the arrangement is made such that even in the state where the broadcast receiving terminal 13 is removed from the cradle 16, the RF signals emitted from the emission sections 33a and 33b can be received, and stable reception can be implemented, as long as RF signals have emission levels conforming to the Radio Wave Law.

When the system is contemplated to be used under various environments, the levels of RF signals received by the external antennas 18a and 18b are not constant at all times, and hence also the emission levels in non-control state are variable. If the power level of an RF signal is excessively high, the level of an input to the broadcast receiving terminal 13 excessively rises. In the case, the system is saturated to be nonfunctionable. If the power level of an RF signal to be emitted is excessively low, the level of an input to the broadcast receiving terminal 13 becomes insufficient, and the input cannot be received. As such, the levels of emission from the emission sections 33a and 33b should be controlled by taking the above into consideration.

Moreover, in Japan, the law restricts the emission of radio waves that can be disturbance radio waves and prohibits radio wave emission exceeding specified electric field intensity. Therefore, the signal-level control sections 31a and 31b each have an automatic variable attenuation control circuit, an automatic variable amplification control circuit, or the like. RF signals are controlled thereby to emission levels receivable by the broadcast receiving terminal 13, and there is additionally provided a function conforming to the sixth section of the Radio Wave Law, “Radio stations for which no license is required.”

The configuration described above enables the broadcast receiving terminal 13 to secure stable RF signals even under low electric field environments. Devices formed to impart various additional functions to the broadcast receiving terminal 13. Examples thereof are a device for supplying the power from the outside, devices for externally outputting video signals and audio signals, and for configuring simple relay stations.

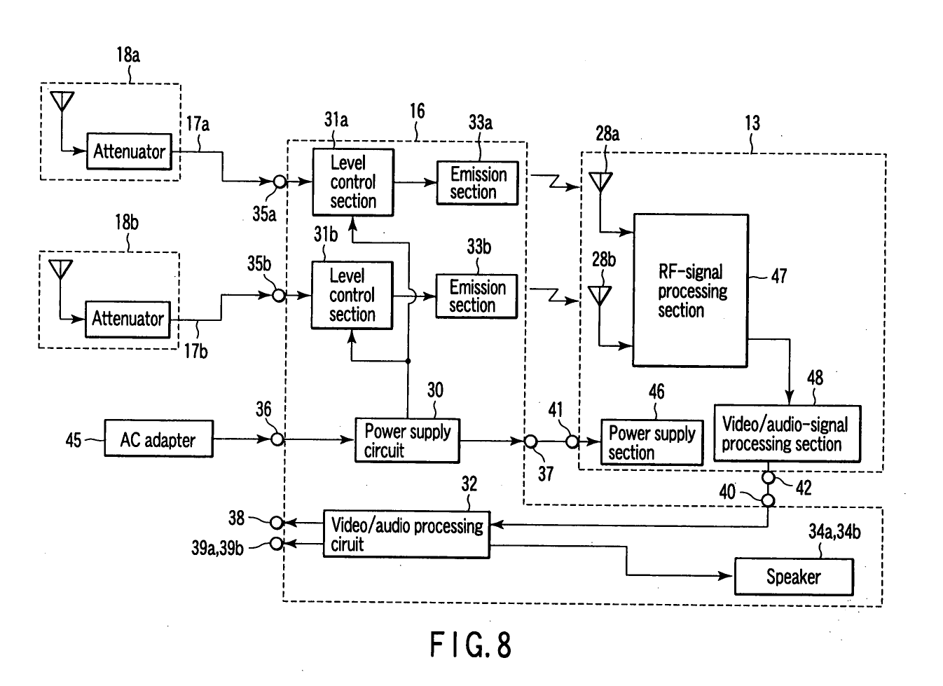

FIG. 8 shows circuit configurations of the external antennas 18a and 18b, the cradle 16, and the broadcast receiving terminal 13. Referring to FIG. 8, RF signals received through the amplifier-containing external antennas 18a and 18b are, respectively, passed through the antenna cables 17a and 17b and supplied to the signal-level control sections 31a and 31b in the cradle 16 via the external-antenna connectors 35a and 35b.

In this case, the signal-level control sections 31a and 31b control the respective levels of emission signals having been output from the respective emission sections 33a and 33b to levels that are receivable by the broadcast receiving terminal 13 and that conform to the Radio Wave Law. Thereafter, the signal-level control sections 31a and 31b output the resultant signals to the emission sections 33a and 33b, respectively.

The emission sections 33a and 33b are respectively disposed in close proximity to and in opposition to the internal antennas 28a and 28b of the broadcast receiving terminal 13. Thereby, the RF signals can be efficiently supplied to the broadcast receiving terminal 13.

These circuits are each provided in units of two systems. The external antennas 18a and 18b and the antenna cables 17a and 17b are provided removably attachable through the external-antenna connectors 35a and 35b.

Mains power from an AC adapter 45 is supplied to a power supply section 46 in the broadcast receiving terminal 13 via the AC adapter connector 36, the power supply circuit 30, the external-power-supply conducting electrode 37, and the connection terminals 41, so that the power is supplied to the broadcast receiving terminal 13.

In addition, in the broadcast receiving terminal 13, the RF signals received by the internal antennas 28a and 28b are restored by a video/audio-signal processing section 48 to the video signal and the audio signal after being processed by an RF-signal processing section 47 for channel selection and the like.

The video signal restored by the video/audio-signal processing section 48 is then supplied to the video/audio processing circuit 32 via the connection terminals 42 and the video/audio input electrodes 40 of the cradle 16, and is then output from the external video output terminal 38.

Also the audio signal restored by the video/audio-signal processing section 48 is supplied to the video/audio processing circuit 32 via the connection terminals 42 and the video/audio input electrodes 40 of the cradle 16, and then is reproduced by the speakers 34a and 34b and output from the external audio output terminals 39a and 39b.

Upon removal of the broadcast receiving terminal 13 from the cradle 16, a connection between the power supply circuit 30 and the power supply section 46 is broken. Thereby, the power supplied from the power supply circuit 30 to the power supply section 46 is discontinued, and the current does not flow to the external-power-supply conducting electrode 37. The power supply circuit 30 senses from the above-described phenomenon that the broadcast receiving terminal 13 has been removed, and controls the signal-level control sections 31a and 31b to amplify the emission levels of the emission sections 33a and 33b, respectively.

More specifically, in the state where the broadcast receiving terminal 13 is installed in the cradle 16, the power supply circuit 30 exhibits the effect of restraining the emission levels such that the signal processing system is not saturated. Upon removal of the broadcast receiving terminal 13 from the cradle 16, the power supply circuit 30 controls the emission levels to rise within a range conforming to the Radio Wave Law to compensate for propagation loss in the spacing.

With the thus-risen levels of the emitted signals, for example, the user can use the broadcast receiving terminal 13 in indoor sites while moving it and can enjoy viewing/listening in any sites as long as the sites are within a range in which signals output from the emission sections 33a and 33b can be received.

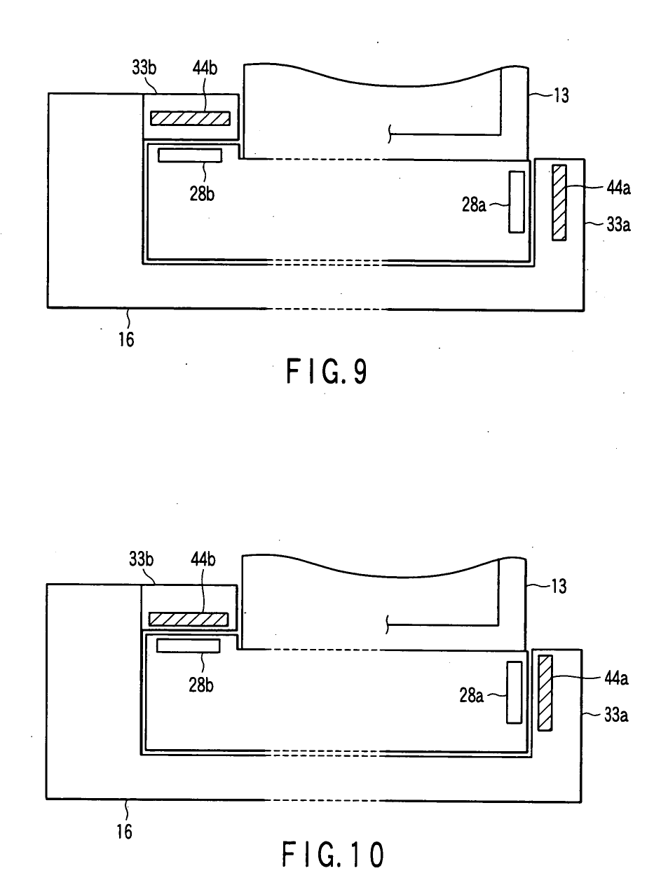

FIG. 9 shows an example of positional relationships between the internal antennas 28a and 28b of the broadcast receiving terminal 13 and the emission sections 33a and 33b of the cradle 16, more particularly, the substrate components 44a and 44b where the pattern antennas 43a and 43b are formed in the state where the broadcast receiving terminal 13 is installed in the cradle 16.

The internal antennas 28a and 28b and the substrate components 44a and 44b are disposed in surface-to-surface opposition to overlap each other at predetermined spacings, respectively. Thereby, RF signals emitted from the pattern antennas 43a and 43b of the substrate components 44a and 44b can be efficiently received by the corresponding internal antennas 28a and 28b.

As shown in FIG. 10, the internal antennas 28a and 28b and the substrate components 44a and 44b may be disposed in surface-to-surface opposition to oppose each other by reducing the spacings therebetween.

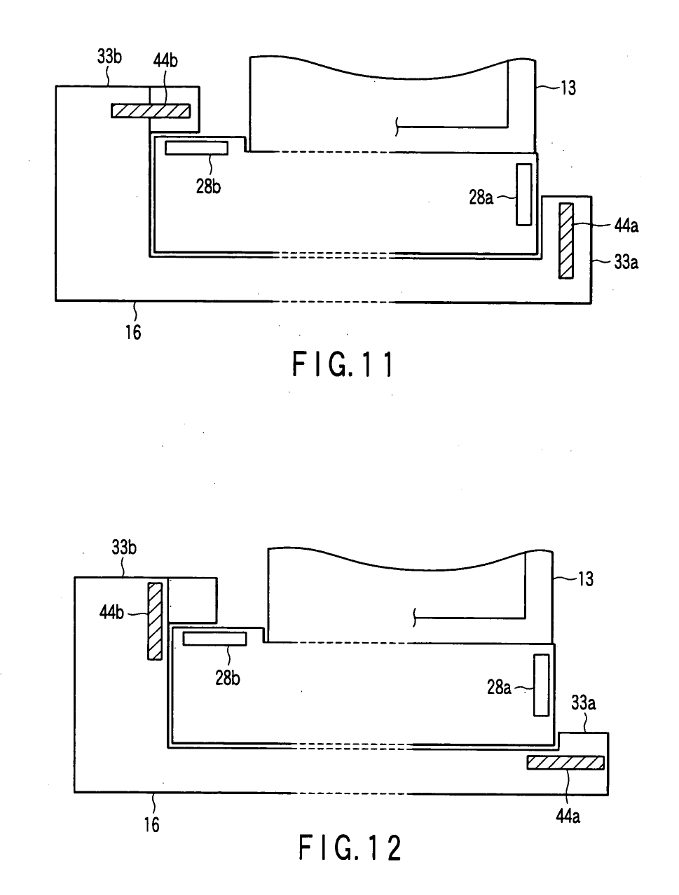

Alternatively, as shown in FIG. 11, the internal antennas 28a and 28b and the substrate components 44a and 44b may be disposed in surface-to-surface opposition to each other to overlap in part with each other at predetermined spacings, respectively.

Still alternatively, as shown in FIG. 12, the internal antennas 28a and 28b and the substrate components 44a and 44b may be disposed not to oppose surface-to-surface to each other, but may be disposed such that, for example, the surfaces thereof are perpendicular to each other.

Of course, the positional relationships between the internal antennas 28a and 28b and the substrate components 44a and 44b are not limited to only those shown in FIGS. 9 to 12, but may also be combined relationships or any other relationships of positions as long as RF signals can be transmitted.

As described above, according to the embodiment, depending on whether or not the power is supplied to the power supply section 46 of the broadcast receiving terminal 13, the power supply circuit 30 of the cradle 16 determines whether or not the broadcast receiving terminal 13 is installed in the cradle 16.

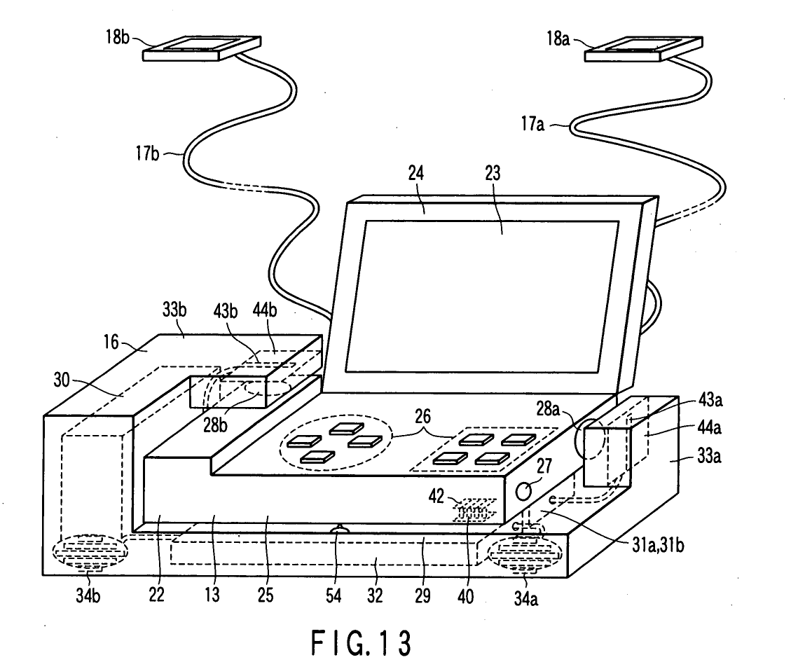

However, the manner of determining whether or not the broadcast receiving terminal 13 is installed in the cradle 16 is not limited to the manner described above. The determination whether or not the broadcast receiving terminal 13 is installed may be made in the following manner. For example, as shown in FIG. 13, a switch 54 is provided in the installation portion 29 for the cradle 16, in which the switch 54 is turned on upon installation of the broadcast receiving terminal 13 and is turned off upon removal thereof, and the installation/removal is determined depending on the on/off operation.

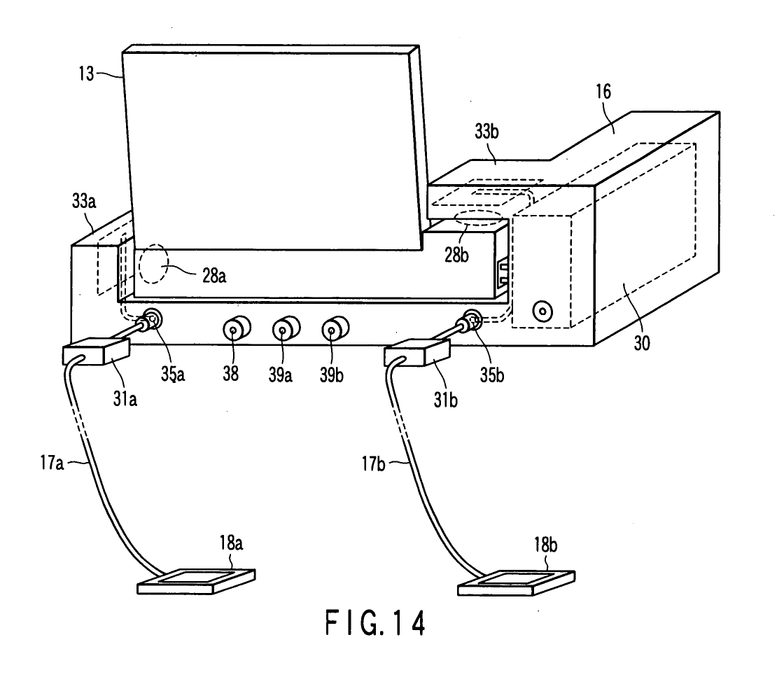

FIG. 14 shows a modified example of the embodiment described above. A description will be made hereinbelow with reference to FIG. 14 in which the same portions as those shown in FIG. 7 are shown with the same reference symbols. The signal-level control sections 31a and 31b built into the cradle 16 in the above-described embodiment are respectively interposed in the courses of the corresponding antenna cables 17a and 17b. Thereby, the signal-level control sections 31a and 31b are provided outside of the cradle 16.

More specifically, the signal-level control sections 31a and 31b become necessary when the external antennas 18a and 18b are used, that is, when the external antennas 18a and 18b are connected to the external-antenna connectors 35a and 35b, respectively. Accordingly, when the external antennas 18a and 18b are not necessary, the signal-level control sections 31a and 31b are removed from the cradle 16 to simplify the configuration of the cradle 16.

Therefore, for use under an environment where the electric field is very low, the broadcast receiving terminal 13 can be configured only by adding simple additional functions, namely the external power supply function, video/audio external output function, and cradle 16.

In addition, the external antennas 18a and 18b, the signal-level control sections 31a and 31b, and the antenna cables 17a and 17b may be set as optional components in product markets. This enables the degree of layout freedom for specification selection by customers to be increased.

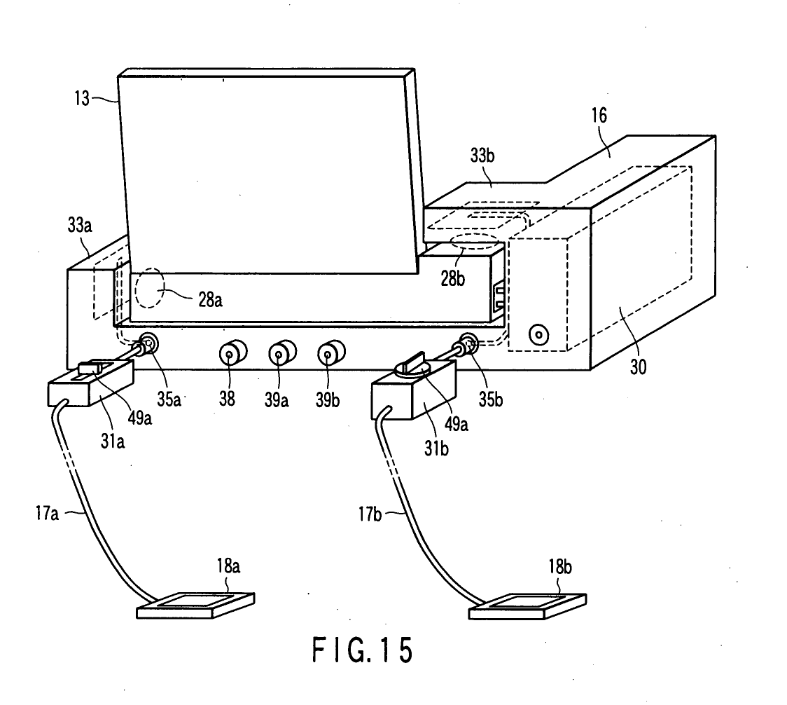

FIG. 15 shows another modified example of the embodiment described above, in which the same portions as those in FIG. 14 are shown with the same reference symbols. Operation devices 49a and 49b are provided in the signal-level control sections 31a and 31b, which are respectively interposed in the courses of the antenna cables 17a and 17b. Using these devices 49a and 49b, the user can manually control the levels of the signal-level control section 31a or 31b.

The embodiment has been described with reference to the examples in which the levels of signals emitted from the emission sections 33a and 33b are detected, and the level control is performed by using either the automatic variable attenuation control circuit or the automatic variable amplification control circuit. In comparison, with the modified example shown in FIG. 15, the user manually controls the signal level while confirming imagery to be displayed on the broadcast receiving terminal 13 or sounds to be output from the broadcast receiving terminal 13.

FIG. 15 shows the example in which, in the signal-level control section 31a connected to the antenna cable 17a on the one side, the operation device 49a is a sliding-type tuning lever. In the signal-level control section 31b connected to the antenna cable 17b on the other side, the operation device 49b is a rotary level-variable pinch tab tuning lever.

For either of the signal-level control sections 31a and 31b, the amplification level or the attenuation level can be varied by operating the operation device 49a or 49b. The level tuning method may be a method of continuously varying the level. However, there can be proposed a fixed or semifixed level control method in which the amplification level or the attenuation level is preset to meet the usage conditions of the user.

With employment of the manual level control methods, circuitry simplification can be implemented for development of systems of the type using the external antennas 18a and 18b, thereby enabling cost reduction to be implanted therefor.

The manual level control can be adapted also in a case where the components in the stages from the external antennas 18a and 18b up to the emission sections 33a and 33b are of types externally mountable in the cradle 16. Further, with level-tuning operation devices being provided in the cradle 16, the manual level control can be adapted even in a case where the signal-level control sections 31a and 31b are built into the cradle 16.

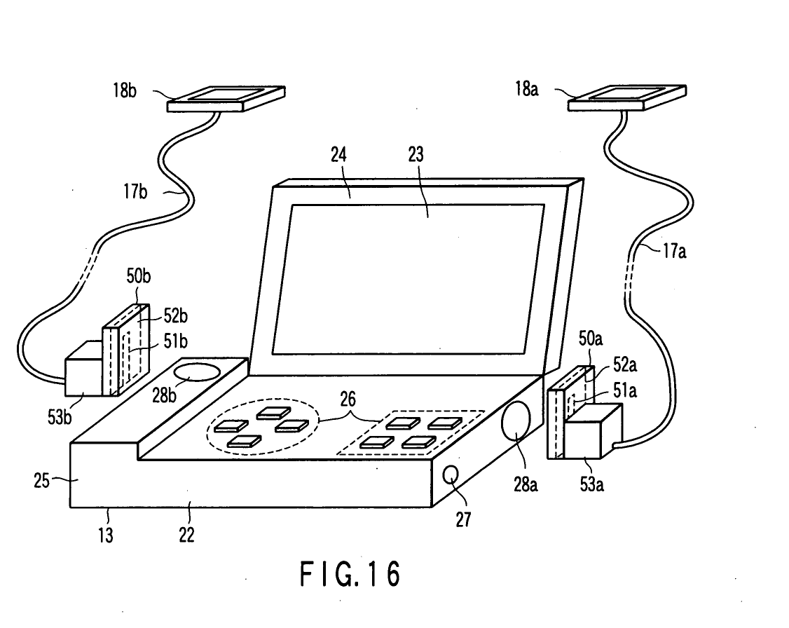

FIG. 16 shows a still another modified example of the embodiment described above, in which the same portions as those in FIG. 6 are shown with the same reference symbols. In the vicinities of the respective internal antennas 28a and 28b of the broadcast receiving terminal 13, there are disposed emission sections 50a and 50b to which the external antennas 18a and 18b are connected via the antenna cables 17a and 17b, respectively, whereby RF signals are supplied to the internal antennas 28a and 28b.

Substrate components 52a and 52b in which pattern antennas 51a and 51b are formed are built into the emission sections 50a and 50b, in which RF signals are emitted from the pattern antennas 51a and 51b. Signal-level control sections 53a and 53b for controlling the levels of the RF signals are connected to input sides of the emission sections 50a and 50b, respectively.

The present invention is not limited to the embodiments as they are, but the invention may be put into effect in a practical application stage by variously modifying the constitutional elements without departing the scope of the present invention. In addition, various other inventions can be formed by appropriately combining the plurality of constitutional elements as disclosed in the embodiments described above. For example, some constitutional elements may be removed from the overall constitutional elements presented in the embodiments. Further, constitutional elements according to different embodiments may be appropriately combined.

1. A cradle having an installation portion in which a predetermined main-body unit is installed, comprising:
first and second level control sections configured to perform level control of radio frequency (RF) signals supplied thereto;
first and second emission sections configured to emit the RF signals having undergone the level control in the first and second level control sections, respectively;
a video input terminal configured to receive a video signal from the main-body unit in a state where the main-body unit is installed in the installation portion;
a signal processing section configured to apply predetermined signal processing to the video signal input to the video input terminal;
a video output terminal configured to output the video signal processed in the signal processing section;
a power input terminal configured to receive power-supply power;
a power supply section configured to generate power to be supplied to the first and second level control sections, the first and second emission sections and the signal processing section in accordance with the power-supply power supplied to the power input terminal;
a power output terminal configured to output the power generated in the power supply section to the main-body unit in the state where the main-body unit is installed in the installation portion;
a detecting section configured to detect installation or non-installation of the main-body unit in the installation portion; and
control section configured to control the RF signals to a first level for the first and second level control sections in a state where the installation of the main-body unit has been detected by the detecting section, and to control the RF signals to a second level higher than the first level for the first and second level control sections in a state where the non-installation of the main-body unit has been detected by the detecting section.

2. A cradle according to claim 1, wherein the detecting section detects the installation or non-installation of the main-body unit in accordance with presence or absence of an electric current at the power output terminal.

3. A cradle according to claim 1, wherein the detecting section detects the installation or non-installation of the main-body unit by using an operation section configured to be controlled to a first operation state in the state where the main-body unit is installed in the installation portion and to be controlled to a second operation state in the state where the main-body unit is not installed in the installation portion.

4. A cradle according to claim 1, further comprising:
first and second external antennas configured to receive RF signals and supply the RF signals to the first and second level control sections, respectively.

5. A cradle according to claim 4, wherein the first and second level control sections are provided at predetermined points of first and second cables used for connecting the first and second external antennas to the cradle.

6. A cradle according to claim 5, wherein the first and second level control sections comprise first and second operation devices to vary levels of the RF signals, respectively.

7. An RF receiver system comprising an RF receiving apparatus installed in a cradle,
the cradle comprising:
first and second level control sections configured to perform level control of radio frequency (RF) signals supplied thereto;
first and second emission sections configured to emit the RF signals having undergone the level control in the first and second level control sections, respectively;
an installation portion configured to install the RF receiving apparatus;
a video input terminal configured to receive a video signal from the RF receiving apparatus in a state where the RF receiving apparatus is installed in the installation portion;
a first signal processing section configured to apply a predetermined signal processing to the video signal input to the video input terminal;
a first video output terminal configured to output the video signal processed in the first signal processing section;
a first power input terminal configured to receive power-supply power;
a first power supply section configured to generate power to be supplied to the first and second level control sections, the first and second emission sections, and the first signal processing section in accordance with the power-supply power supplied to the first power input terminal;
a power output terminal configured to output the power generated in the first power supply section to the RF receiving apparatus in the state where the RF receiving apparatus is installed in the installation portion;
a detecting section configured to detect installation or non-installation of the RF receiving apparatus in the installation portion; and
control section configured to control the RF signals to a first level for the first and second level control sections in a state where the installation of the RF receiving apparatus has been detected by the detecting section, and to control the RF signals to a second level higher than the first level for the first and second level control sections in a state where the non-installation of the RF receiving apparatus has been detected by the detecting section, and
the RF receiving apparatus comprises:
first and second antennas configured to receive the RF signals emitted from the first and second emission sections, respectively;
a second signal processing section configured to restore a video signal from the RF signals received by the first and second antennas;
a display section configured to display the video signal restored in the second signal processing section;
a second video output terminal configured to output the video signal restored in the second signal processing section to the video input terminal in the state where the RF receiving apparatus is installed in the installation portion;
a second power input terminal configured to receive the power-supply power output from the power output terminal in the state where the RF receiving apparatus is installed in the installation portion; and
a second power supply section configured to generate power to be supplied to the second signal processing section and the display section in accordance with the power-supply power supplied to the second power input terminal.

8. An RF receiver system according to claim 7, further comprising:
first and second external antennas configured to receive RF signals and supply the RF signals to the first and second level control sections, respectively.

9. A cradle according to claim 8, wherein the first and second level control sections are provided at predetermined points of first and second cables used for connecting the first and second external antennas to the cradle.

10. An RF receiver system according to claim 9, wherein the first and second level control sections comprise first and second operation devices to vary levels of the RF signals, respectively.

11. An RF receiver system according to claim 7, wherein the first and second antennas are disposed in surface-to-surface opposition to the first and second emission sections at predetermined spacings, respectively, in the state where the RF receiving apparatus is installed in the cradle.

12. An RF receiver system according to claim 7, wherein the first and second antennas are disposed in surface-to-surface opposition to each other to overlap in part with the first and second emission sections at predetermined spacings, respectively, in the state where the RF receiving apparatus is installed in the cradle.

13. An RF receiver system according to claim 7, wherein the first and second antennas are disposed in surface directions different from those of the first and second emission sections, respectively, in the state where the RF receiving apparatus is installed in the cradle.

14. An RF receiving method to be executed by installing an RF receiving apparatus in a cradle, wherein:
the cradle performs level control of received RF signals in first and second level control sections and emittes the RF signals after the level control;
the RF receiving apparatus receives the individual RF signals emitted by the cradle, restores a video signal, and outputs the video signal;
the cradle applies predetermined signal processing to the video signal output by the RF receiving apparatus and outputs the video signal;
the cradle generates power to be used in the cradle in accordance with input power-supply power and outputs the power to the RF receiving apparatus;
the cradle detects installation or non-installation of the RF receiving apparatus; and
the cradle performs level control of the RF signals to be emitted to the RF receiving apparatus to a first level in a state where the installation of the RF receiving apparatus has been detected, and performs level control of the RF signals to be emitted to the RF receiving apparatus to a second level higher than the first level in a state where the non-installation of the RF receiving apparatus has been detected.

15. An RF receiving method to be executed by installing an RF receiving apparatus in a cradle, according to claim 14, wherein:
first and second external antennas configured to receive RF signals and supply the RF signals to the first and second level control sections, respectively.
